(19) United States
(12) Patent Application Publication
(10) Pub. No.: US 2019/0133356 A1
(43) Pub. Date: May 9, 2019

(54) Natural Drinking Training Apparatus and Training System Facilitating Normal Development of Oral Postures, Oral Movements, and Jaw/Mouth Anatomy

(71) Applicant: LESLIE KESSLER-SEED, CHEVY CHASE, MD (US)

(72) Inventor: LESLIE KESSLER-SEED, CHEVY CHASE, MD (US)

(21) Appl. No.: 16/241,903

(22) Filed: Jan. 7, 2019

Related U.S. Application Data
(63) Continuation-in-part of application No. 15/337,106, filed on Oct. 28, 2016, now abandoned.
Application No. 15/337,106 is a continuation-in-part of application No. 15/218,786, filed on Jul. 25, 2016, now abandoned.

(51) Int. Cl. A47G 19/22; B65D 47/12; B65D 51/18; B65D 25/28; B65D 55/16; A61J 9/00

(52) U.S. Cl. CPC A47G 19/2272; B65D 47/12; B65D 51/18; B65D 25/2811; B65D 2251/009; A61J 9/005; A61J 9/006; B65D 2251/0025; B65D 55/16

(57) ABSTRACT

A food pouch spout and lid apparatus equipped with a lip stopper is described. The apparatus is designed to augment or replace the existing food pouch spout of a conventional food pouch in order to prevent speech and development issues. Such issues are known to be prevalent among children who frequently use sippy cups and food pouches which are not equipped with a lip stopper. The lip stopper of the present invention ensures that the child is unable to place the spout of the food pouch or straw into the mouth beyond the lips, ensuring the prevention of normal speech, palate, and alveolar development. One embodiment posits the integration of the lip stopper and capper apparatus into the spout of a food pouch at the point of manufacturing, eliminating the need for additional accessories.

### CONTINUITY

This application is a Continuation-in-Part of Continuation-in-Part application Ser. No. 15/337,106, filed on Oct. 28, 2016, which is a Continuation-in-Part of non-provisional patent application Ser. No. 15/218,786, filed on Jul. 25, 2016, and priority is claimed thereto.

### FIELD OF THE PRESENT INVENTION

The present invention relates generally to the facilitation of pouch food consumption by an individual, and more specifically relates to a pouch capper apparatus and system configured to ensure the correct and natural development of the palate and jaw of a child (or impaired adult) via the placement and use of a lip stopper.

### BACKGROUND OF THE PRESENT INVENTION

Babies and young children learning to eat from containers other than a baby bottle or a mother's nipple are often provided fluidic/pureed food within conventional child food pouches. Often these food pouches are easy to transport, which is initially a benefit to many parents and caregivers, as less time is spent cleaning up messes. Food pouches traditionally have a single opening disposed at a top of the pouch, and have a protrusion which is not designed similar to a nipple. Still, the child is required to actively suckle on the spout-like protrusion of the food pouch, and occasionally even squeeze the pouch in order for the food to travel to the mouth of the child for consumption.

While this action excels as preventing waste and spillage, it unfortunately comes paired with several detrimental consequences. As a result of the use of conventional food pouches, children can learn an incorrect, developmentally detrimental, and unrealistic method of eating, making it more difficult and time consuming to unlearn an opposed muscle pattern. The use of oral muscles during use of the food pouches requires and enforces the infantile suckling of a nipple far beyond infancy, thereby inhibiting the child's ability to develop a normal eating and drinking pattern. The normal or conventional drinking pattern is in exact opposition of the suckle pattern required by the formed spout of a food pouch.

Additionally, use of food pouches can cause children to develop oral fixations or complexes, reinforcing the need to suck thumbs and pacifiers later into childhood. Often, children bite the spout because they have not been afforded the opportunity to develop jaw stability and control. Similarly, due to sucking on the pacifier-like protruding spout of conventional food pouches, children are prone to speech disorders, as well as disordered lingual mandibular, alveolar rest posture, as the muscles in their tongues are not trained in the traditional mature manner. When the child locks his or her mouth onto the pacifier-like protrusion of the food pouch, the tongue is forced in an unnatural direction via a forward thrust or anchored down to the bottom of the mouth (or both), which most often causes swallowing disorders, speech disorders, including, but not limited to speech sounds such as “S,” “Z,” “Ch,” “Sh,” “R,” “L,” “N,” “D,” and “T,” as well as an impaired lingual, mandibular/alveolar rest posture, making initial and continued pronunciations of words to be impaired. This often leads many children to require speech, swallowing, and oral motor therapy to cure these disorders. This process is rather timely, usually taking several years, and in many cases, is very expensive.

Likewise, dental and oral structural damage can occur from the use of food pouches as well as sippy cups, which is exacerbated by the extended duration of time required to train children to drink from a standard cup, or to eat food via a spoon. The longer a child uses a food pouch spout which extends beyond the lips of the child, the greater the time it takes to ‘un-train’ the damaging behavior of using non-conventional muscle tension and movements to eat/drink. This ‘un-training’ followed by correct muscle training/therapy can only be accomplished through swallowing therapy provided by a speech pathologist who is properly trained to provide this therapeutic treatment. Similarly, the longer the bad habit of eating non-conventionally persists, the longer and more difficult it will be to reverse.

It is known that children must practice the normal, intra-oral exercise of eating, including maintaining the freedom of lingual range of motion, in order to learn to eat or drink correctly without the tongue being held down by the formed spout of a food pouch or sippy cup. With the use of a food pouch spout, the tongue tip elevation to the alveolar ridge is completely inhibited. It is this posture that is essential in developing a normal drinking pattern. As such, the development of the correct eating and drinking posture and pattern is essential in developing a normal eating/drinking pattern and lingual/alveolar resting posture. A normal lingual/alveolar resting posture is necessary for normal palate development (expansion).

It has been said that the tongue is the ‘place saver’ for the palate. The tongue, when in the correct resting posture, exerts almost constant pressure on the hard palate, starting at the alveolar ridge, and facilitates the normal palate expansion to coincide with the growth of the tongue and palate. This forms a normally sized and shaped palate. Depriving the child's tongue access to the palate, via a formed spout of a food pouch can severely inhibit essential palatal widening, causing a high-vaulted, narrow palate, which is a structural abnormality in the mouth. This abnormality then causes dental and jaw problems and abnormalities, all of which can be very costly to repair.

Additionally, use of food pouches by children can also cause ear infections. Aside from being an illness, ear infections can be temporarily detrimental to a child's hearing, as they may cause temporary hearing loss known as conductive hearing loss. As it is known that the first three years of a child's life are critical for the development of speech and language, any time with hearing loss in early development can hinder speech and language development, and may cause functional attention problems.

Thus, there is a need for a new form of food pouch spout configured to prohibit the child from placing the food pouch spout into the mouth beyond the lips in order to encourage the proper development of the palate and alveolar ridge. Importantly, such a food pouch spout would allow the normal unhampered movement and normal exercise of the tongue to allow development of a normal lingual/alveolar resting posture and normal palate growth/expansion. This resting posture tongue placement is identical to the correct swallow process and the posture of many normal speech/sound productions.

### SUMMARY OF THE PRESENT INVENTION

The present invention is a new food pouch spout and cap system for children, configured to educate, facilitate, and reinforce the normal motor skills used for eating from a food pouch, facilitating the learning of proper lip, tongue, and neck posture/movement. The apparatus of the present invention is a new and improved food pouch spout, configured to either attach directly to conventional food pouch spouts to limit their extension into the mouth of the child, or to be directly built-in to the food pouch spout during manufacturing. The body of the food pouch spout is preferably fashioned of an impact-resistant material, such as a BPA-free plastic or acrylic polymer, and is preferably molded into a functional shape for placement between the lips of the child. The food pouch spout, referenced as a ‘capper,’ is equipped with a lip stopper which extends horizontally from the vertical orientation of the food pouch spout, and is configured to prevent the placement of the food pouch spout beyond the lips into the mouth. As such, food pouches equipped with the food pouch spout of the present invention cannot easily be placed beyond the lips, into the mouth where damage may occur, but instead is configured to rest between the lips of the child, preventing damage to speech development, palate growth, and other common conditions resulting from food pouch and sippy cup use.

Additionally, most embodiments of the present invention are equipped with a lid. The lid preferably screws or press-fits onto the body, so as to be difficult to remove for the child, and is easily removed for cleaning. Such a lid inhibits unwanted spillage of the food contained with the food pouch; however it may be removed easily by an adult for cleaning.

The concept of the lip stopper of the capper of the present invention may also be present on a straw configured for use within a drinking cup for children. In such embodiments, the straw equipped with a lip stopper is preferably present within a cup configured with a bottom which is preferably weighted to help encourage the child to put the cup down in the correct, upright orientation. As such, the center of gravity of the present invention is preferably near the bottom of the body of the present invention.

Some embodiments of the present invention may be equipped with a straw which extends from above the top of the cup lid. In such embodiments, the straw is equipped with a built-in lip stopper. This lip stopper will only allow the straw to enter a position disposed between the child's lips, not beyond the lips into the mouth. This ensures that the child cannot suckle on the straw, preventing dental and speech damage from straw use. Regular straw use can be just as damaging as a spout since the child can put the straw into the mouth well beyond the lips and suckle the straw in the exact same way the child suckles a sippy spout. A lip stopper is disposed on the straw approximately one-eighth to one-quarter inch from the end of the straw to prevent the user from placing the straw beyond the lips into the mouth during use.

One iteration of the straw-based embodiment includes the use of a one-way valve. Use of this one-way valve will ensure no spillage. Other embodiments of the present invention may include lids equipped with straws having lip stoppers at decreasing distances from the tip of the straw, starting at approximately three quarters of an inch from the straw, progressing to a final cap equipped with a straw extending one quarter to one eight of an inch from the top of the straw. Such a series of lids are designed for children who have learned incorrect straw/mouth placement, and require the progressive ‘grading down’ of the length of the straw tip in order to eventually achieve the normal and correct placement of the straw between the lips of the mouth.

Some instances of this embodiment are preferably equipped with a lip stopper/straw lid, which is configured to press-fit onto the opening of the straw and butts up to the lip stopper, helping to keep the straw and lip stopper portion of the present invention sanitary when not in active use. Such a lip stopper/straw lid is preferably tethered to one of the handles of the present invention in order to prevent loss. The tether is preferably composed of silicone or a similarly flexible plastic.

As previously stated, this arrangement can function well for use on food pouches with a spout-like pouch outlet. The system of the present invention includes the use of a food pouch component, which is configured for use on conventional food pouches for babies and children. The capper is also equipped with a lip stopper, configured to limit the extent to which the capper can extend beyond the lips into the mouth of the child. The capper is designed to fit atop the stock spout or straw-like protrusion from the pouch. The capper is placed on the pouch spout manually. The child may then consume the food within the food pouch via the capper, and is unable to place the capper beyond his or her lips, facilitating a normalized oral pattern of use. It will be possible for the capper to fit over some makes/sizes of straws. Additionally, the food pouch capper is also equipped with a built-in lid, which preferably press-fits onto the top of the capper, and butts up to the lip-stopper, sealing the contents within the food pouch, and helping to keep dirt and debris from entering the food spout, or coming into contact with the lip stopper.

A third primary embodiment of the present invention is preferably integrated into the default spout of the food pouch during manufacturing, and as such, is equipped with a built-in lip-stopper integrated into the spout. In such embodiments, the user need not install a capper, as one is effectively built into the food pouch itself.

It should be understood that the capper portion of the present invention is external to the cup portion of the present invention, and that use of both the food pouch capper component as well as the drinking apparatus helps to eliminate issues that inhibit the development of oral postures, oral movements, and jaw/mouth anatomy as discussed in the background.

### BRIEF DESCRIPTION OF THE DRAWINGS

The present invention will be better understood with reference to the appended drawing sheets, wherein:

FIG. 1 is a perspective view of an embodiment of the present invention, detailing the front side and a straw equipped with the lip stopper of the present invention arranged for use with a cup.

FIG. 2 depicts a first embodiment of the capper of the present invention, which is configured to sit atop a spout of a food pouch.

FIG. 3 exhibits a second embodiment of the capper of the present invention shown affixed to a food pouch.

FIG. 4 shows an embodiment of the capper of the present invention, shown with the built-in lid closed, as seen from the side, affixed to a food pouch.

FIG. 5 shows a flow chart detailing the process of use of the present invention.

FIG. 6 depicts a primary embodiment of the present invention, exhibiting the lid and lip stopper of the present invention.

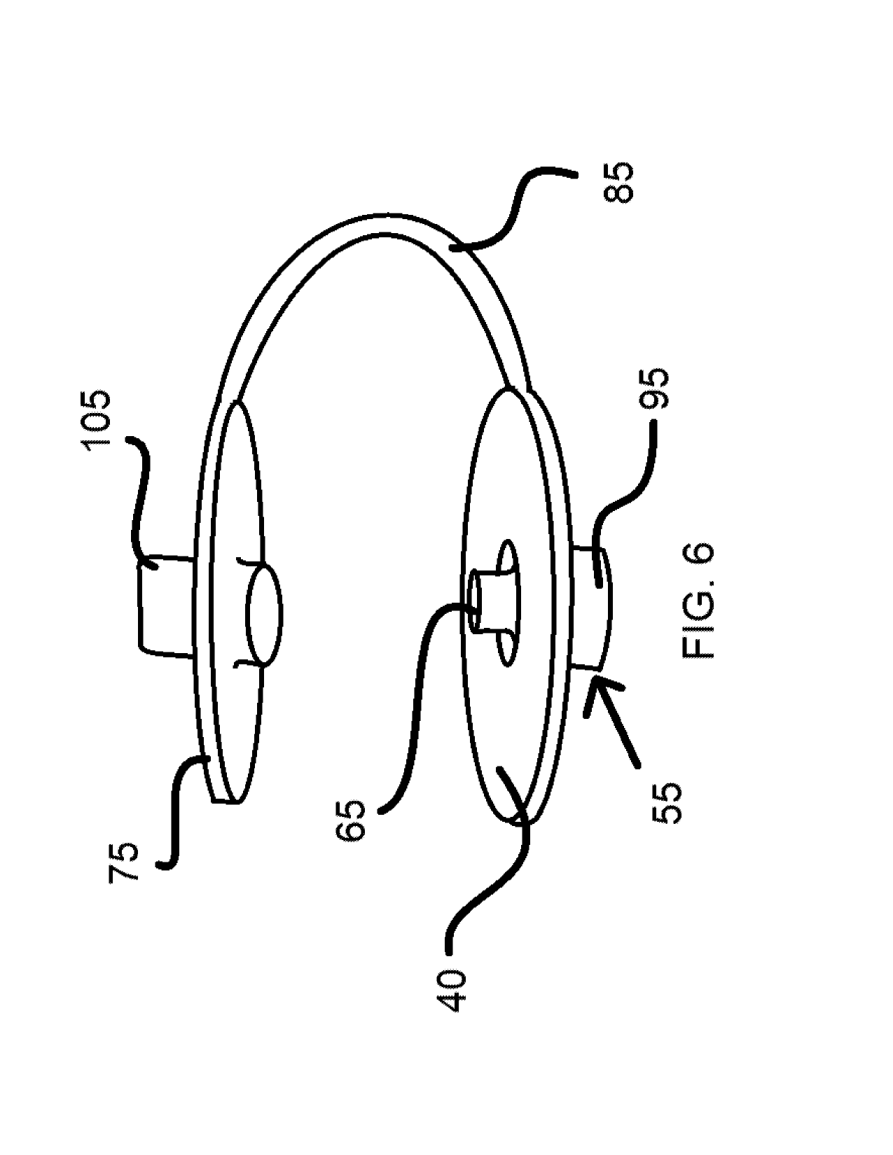

### DETAILED DESCRIPTION OF THE PREFERRED EMBODIMENT

The present invention is a food pouch spout and capper apparatus designed to prevent speech and palate developmental issues in children, including infants and babies. The present invention amounts to a replacement food pouch spout referenced as a capper (55) equipped with an opening (65), base (95), and lip stopper (40).

There are preferably three primary embodiments of the present invention: a first embodiment having an opening (65) equipped with a lip stopper (40) which is integrated into the default spout of the food pouch itself, a second embodiment having an opening (65) equipped with a lip stopper (40) which is configured to attach to (or rest on top of) an existing, default food pouch spout of the food pouch, referenced as a ‘capper,’ and a third embodiment configured for use on a straw-like spout (115) similarly equipped with a lip stopper (40), configured to facilitate safe drinking of fluids from a cup. Such embodiments, as described below, may be equipped with a cup apparatus to house the straw or similar spout-like protrusion equipped with the lip stopper (40) of the present invention.

The system of the present invention includes the use of a capper (55), which is configured for use on conventional food pouches for babies and children. The capper (55) is also equipped with a lip stopper (40) configured to limit the extent to which the capper (55) can extend beyond the lips into the mouth of the child. Additionally, the capper (55) is equipped with a lid (75), which is permanently connected to a base (95) of the capper (55) via a tether (85). The lid (75) is configured to press-fit onto an opening (65) of the capper (55) via a press-fit cavity (105), preventing contamination of the contents of the food pouch, the entirety of the lip stopper (40), as well as the capper (55) itself. The capper (55) is designed to fit atop the stock spout or similar straw-like protrusion from the pouch. The child may then consume the food within the food pouch via the capper (55), and is unable to place the opening (65) of the capper (55) beyond his or her lips.

The capper (55), lid (75), and tether (85) of the present invention are preferably fashioned out of a rubber, silicone, or similar food-grade, flexible, water-tight material. The capper (55) is configured to form an air-tight seal on the food pouch. The lip stopper (40) disposed on the capper (55) is preferably built into the capper (55), such that the capper (55) and lip stopper (40) are a unitary piece which can be easily cleaned. As such, embodiments of the capper (55) of the present invention are preferably dishwasher-safe.

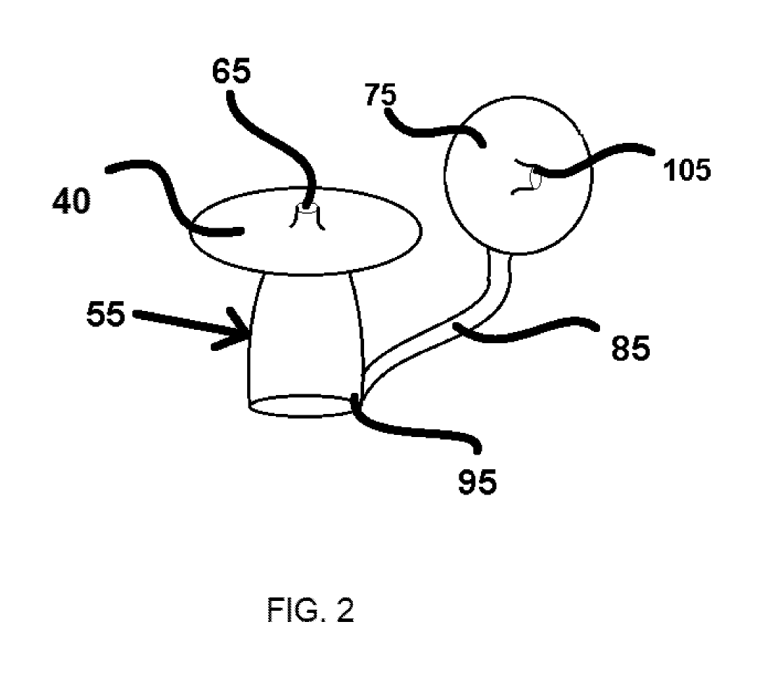

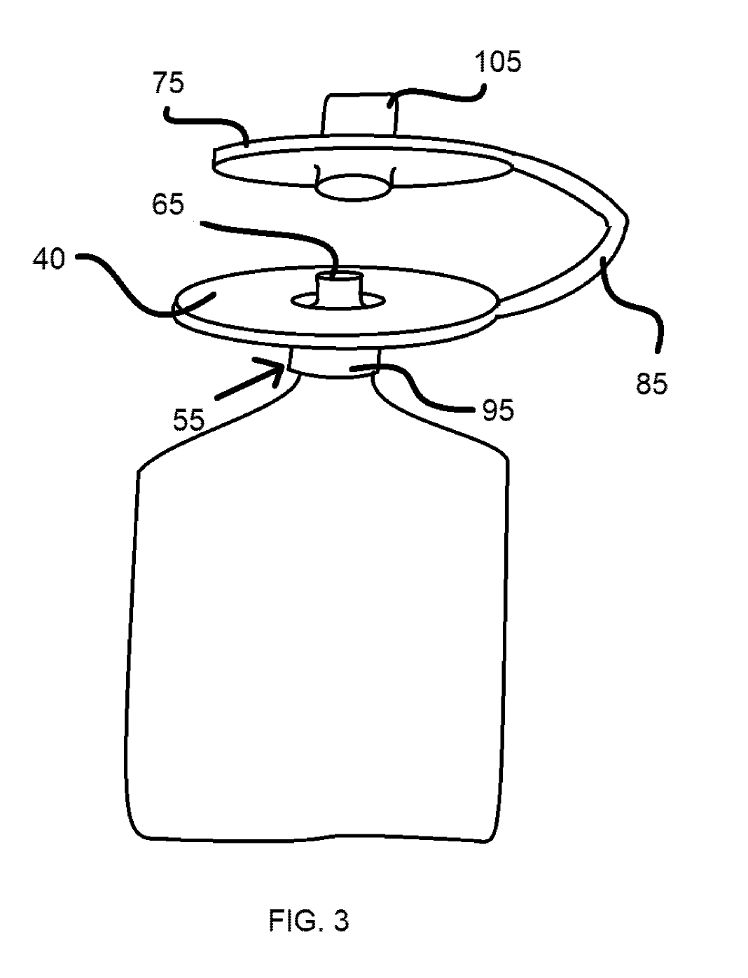

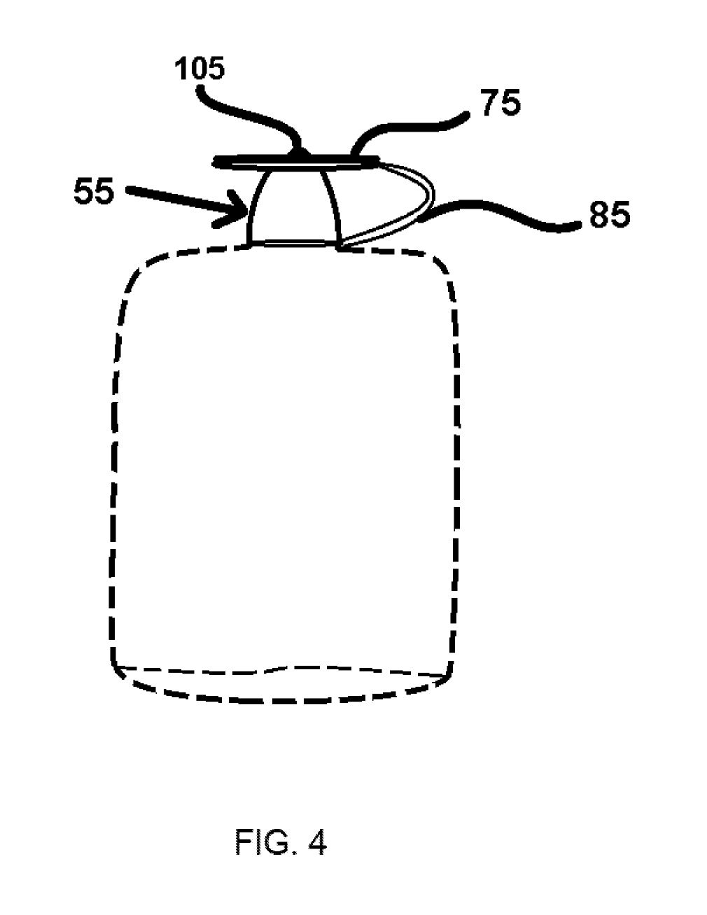

It should be understood that the capper (55) of the present invention is equipped with an opening (65) to facilitate the consumption of food through the capper (55), as shown in FIG. 2 and FIG. 3. It is also possible for the capper (55) to fit over certain conventional straw widths. It should be understood that the opening (65) of the capper (55) is approximately ¼ inch above the lip stopper (40), preventing the opening (65) from traveling beyond the lips of the child during use. The lid (75) is configured to be slightly larger in diameter than the lip stopper (40) to facilitate easy removal of the lid (75) from the opening (65). Similarly, the press-fit cavity (105) of the lid (75) is slightly larger in diameter than the opening (65), allowing the press-fit cavity (105) to securely slide over the opening (65) when the lid (75) is sealed, as shown in FIG. 3 and FIG. 4.

It should be noted that the capper (55) of the present invention does not inhibit the flow of food from the pouch. Other pouch toppers on the market can make it difficult for the child to get the food out of the food pouch easily via suction. Additionally, it should be noted that the capper (55) of the present invention differs from other pouch toppers on the market in that it is equipped with the lip stopper (40) to prevent damage to the child from use, as well as a lid (75) to prevent contamination unlike other devices on the market.

Additionally, it should be understood that the capper (55) of the present invention may be equipped with a means by which it may be affixed to the body or spout of the food pouch when not in use in order to prevent loss of the capper (55). For example, the capper (55) may be equipped with an attachment ring configured to wrap around and adhere to the body and/or neck of the spout of the food pouch.

Regarding the third embodiment of the present invention, as those configured with a straw or similar spout equipped with a lip stopper (40), the following applies:

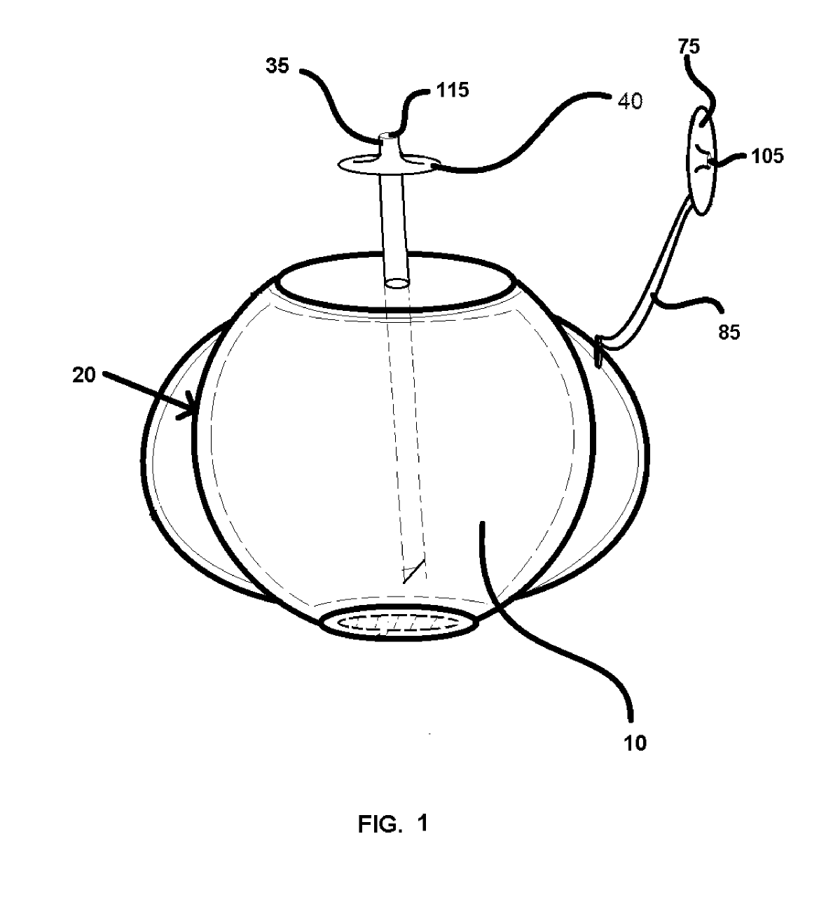

As depicted in FIG. 1, some embodiments of the present invention are preferably integrated into a top of a specially designed straw for use within cups for the consumption of liquids and liquid-based foods such as smoothies. As shown, the third embodiment of the present invention employs a straw cap in which a straw (35) is equipped with a lip stopper (40) and a one-way valve may be present to afford the greatest protection against spilling, yet easy access for cleaning. A lid (75) is preferably provided to seal the top of the straw, preventing contamination of the straw (35) when it is not in use. The lid (75) is equipped with a tether (85) which secures the lid (75) to one of the handles (or to the straw (35) itself) so that it is not lost during use of the present invention. The tether (85) may easily be removed from the handle for cleaning by the owner. The lid (75) is configured to cover both the opening at the top of the straw (35), as well as the entirety of the lip stopper (40) of the straw (35), ensuring that all points of contact between the present invention and the mouth/lips of the child are kept clean until used. A portion of the lid (75), shown as the press-fit cavity (105) is configured to press-fit onto a straw opening or tip of the straw (35) to help keep the lid (75) in place securely.

It is envisioned that the straw (35) of the third embodiment extends nearly to the bottom of the container portion (10). This is to allow the consumption of all of the liquid housed within the container portion (10) while maintaining correct drinking posture. As with conventional straws, the present invention preferably must remain upright and nearly level for the straw to function correctly. The child is required to use a chin tuck or tilt his or her head down for the lips to meet the end of the straw (35). Adequate training of drinking with a straw is important because it works to strengthen the tongue and lip muscles. Adequate strength and posturing of the lip and tongue muscles is necessary for proper swallowing, and for the correct production of many speech sounds.

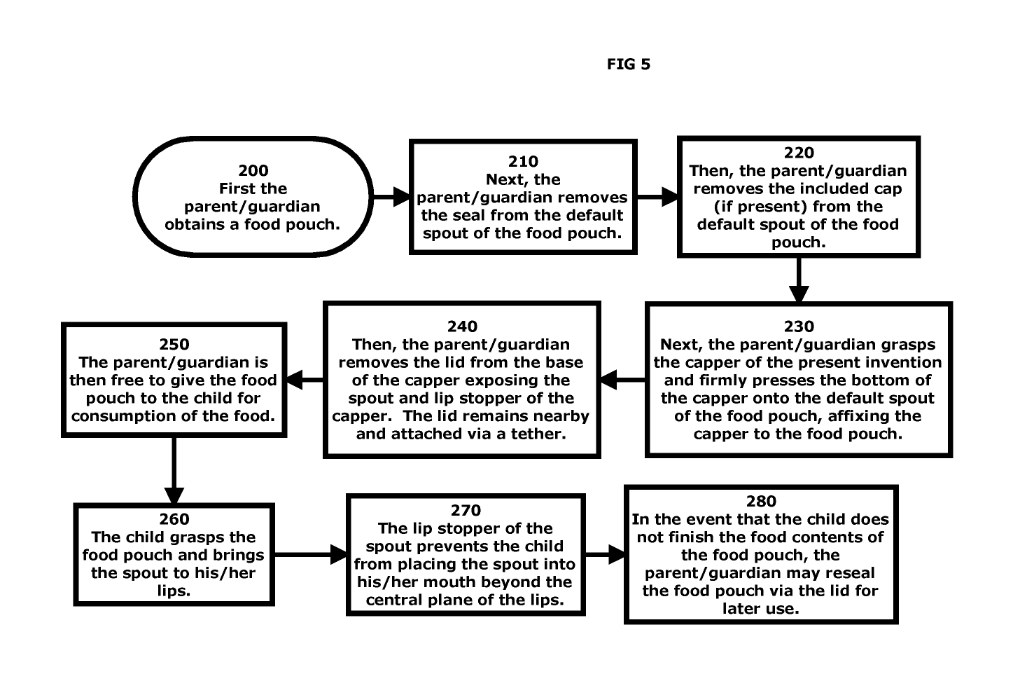

The process of use of the non-integrated capper embodiment of the present invention, as depicted in FIG. 5, is preferably as follows:
1. First the parent/guardian obtains a food pouch. (200) If the food pouch purchased is equipped with the integrated lip stopper spout of the first embodiment of the present invention, the parent/guardian may progress to step 5.
2. Next, the parent/guardian removes the seal from the default spout of the food pouch. (210)
3. Then, the parent/guardian removes the included cap (if present) from the default spout of the food pouch. (220)
4. Next, the parent/guardian grasps the capper of the present invention and firmly presses the bottom of the capper onto the default spout of the food pouch, affixing the capper to the food pouch. (230)
5. Then, the parent/guardian removes the lid from the base of the capper exposing the spout and lip stopper of the capper. The lid remains nearby and attached via a tether. (240)
6. The parent/guardian is then free to give the food pouch to the child for consumption of the food. (250)
7. The child grasps the food pouch and brings the spout to his/her lips. (260)
8. The lip stopper of the spout prevents the child from placing the spout into his/her mouth beyond the central plane of the lips. (270)
9. In the event that the child does not finish the food contents of the food pouch, the parent/guardian may reseal the food pouch via the lid for later use. (280)
10. It should be noted that, upon completion of the food contents, the parent/guardian may remove the capper from the food pouch to be washed either by hand or in a dishwasher for later reuse.

Alternate embodiments of the present invention include variations on the coloring, texture, and material of the body and lid of the present invention. Additionally, some alternate embodiments of the present invention may employ a varied number of drinking holes to provide even faster flow of liquid via the straw (35) from the container portion (10) of the present invention as the child's skill increases.

It should be understood that all embodiments of the present invention are envisioned for use by all children, including babies, physically impaired children, and some physically impaired adults.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A method of consuming nutrients from a food pouch by a child without damaging oral functionality, providing for natural growth of teeth and palate of the child, and fostering the development of a mature swallow pattern comprising:
grasping the food pouch;
wherein the food pouch is equipped with a spout;
affixing a base of a capper to the spout via a press-fit cavity disposed within the base;
wherein the capper is equipped with a lip stopper disposed approximately ¼^{th} of an inch from an opening of the capper;
the child grasping the food pouch;
the child placing the opening of the capper between his/her lips;
the capper extending no farther into the child's mouth as it is stopped by the lip stopper against lips of the child, preventing the child from placing the capper into the mouth of the child;
the child sucking at the opening of the capper;
the nutrients flowing out of the opening into the mouth of the child via the capper and
the child maintaining healthy oral posture, development of the mature swallow pattern, allowing normal palatal growth, and speech development.

2. A method of preventing the occurrence of oral problems, speech problems, malformations and impaired oral preparatory swallow process of a child traditionally caused by improper suckling comprising:
grasping a food pouch;
affixing a capper to a spout of the food pouch;
wherein the capper is equipped with an opening, a lid, and a lip stopper;
the child placing the opening of the capper between his/her lips;
the lip stopper of the capper preventing the child from inserting the opening of the capper beyond the lips of the child;
the child sucking at the opening, channeling food from the food pouch into the capper, and out of the opening; and
the child receiving food into his or her mouth without negatively affecting palate growth, mature swallow pattern development, normal lingual resting posture, and speech development.

3. A method for consuming a fluidic/pureed food product by a child comprising:
placing a capper in contact with a container containing the fluidic/pureed food product;
wherein a center of the capper is hollow to permit the passage of the fluidic/pureed food product;
wherein the capper is equipped with a planar lip stopper disposed one-eighth to one-quarter of an inch from an output end of the capper;
the child brining an opening of the capper to his/her lips;
the lip stopper preventing the child from placing the output end of the capper beyond his/her lips;
the child sucking on the capper; and
the capper delivering the fluidic/pureed food product to the mouth of the child via the output end of the capper.

4. The method of claim 3, wherein the lip stopper is in communication with a spout of the container.

5. The method of claim 3, wherein the capper is placed into contact with a spout of the food pouch during manufacturing of the food pouch container.
